(19) United States
(12) Patent Application Publication
(10) Pub. No.: US 2016/0371731 A1
(43) Pub. Date: Dec. 22, 2016

(54) Identifying Media Store Users Eligible for Promotions

(71) Applicant: Google Inc., Mountain View, CA (US)

(72) Inventors: Ibrahim Elbouchikhi, San Francisco, CA (US); Ficus Kirkpatrick, Los Altos Hills, CA (US)

(21) Appl. No.: 15/244,064

(22) Filed: Aug. 23, 2016

Related U.S. Application Data
(63) Continuation of application No. 14/299,030, filed on Jun. 9, 2014.
(60) Provisional application No. 61/862,012, filed on Aug. 3, 2013.

(51) Int. Cl. G06Q 30/02

(52) U.S. Cl. CPC G06Q 30/0255

(57) ABSTRACT

A developer/requestor may select a subset of users for a promotion by querying a database; however, the developer may not be provided with specific details about each user (e.g., purchase history, browsing history, etc.). The system returns a response to the query that obfuscates a user's data while simultaneously providing the developer with a response to indicate to the developer whether or not a user or group of users is promotion eligible based on the developer's criteria. The developer may dispatch a promotion to the one or more users determined to be promotion eligible.

### CROSS REFERENCE TO RELATED APPLICATION

This application claims priority to non-provisional application Ser. No. 14/299,030, filed on Jun. 9, 2014, which claims priority to provisional application No. 61/862,012, filed on Aug. 3, 2013, the disclosure of each of which is incorporated by reference in its entirety.

### BACKGROUND

Media stores, which provide applications, music, movies, books, etc. for download and/or purchase, are typically linked to a particular user account. The media store may collect or possess information about purchases, viewing/browsing behavior of a user associated with the user account. For example, a particular user may have an interest in documentary movies and arcade games as indicated by the user's browsing and purchase history on the media store. The collected information may be utilized to generate a user profile which may further be utilized to group or cluster the user with other individuals who enjoy documentaries and arcade games. Developers of applications or content providers associated with the media store, may not have access to the analytic data such as this and otherwise (e.g., purchase history) due to privacy concerns, lack of access to information about a user's interaction with items other than the developer's own items in the store, lack of resources to store or process the information, or the like.

### BRIEF SUMMARY

According to an implementation, a query for a promotion eligibility for one or more users may be received form a requestor. User data that are unavailable to the requestor for the one or more users may be obtained. The user data may be based on at least one of a user's purchase history, a browsing history, and a content specific history. A determination may be made as to whether the one or more users is eligible for a promotion based on the query for the one or more users and the user data. A response to the query may be returned to the requestor.

In an implementation, a system is provided that includes a database for storing purchase information for one or more users. A processor may be coupled to the database and configured to receive a query for a promotion eligibility for one or more users. The processor may obtain user data that are unavailable to the requestor for the one or more users. The user data may be based on at least one of a user's purchase history, a browsing history, and a content-specific history. The processor may determine whether the one or more users is eligible for a promotion based on the query for the one or more users and the user data. A response to the query may be provided.

In an implementation, an application may be launched on a device associated with a user. A local application purchase activity may be determined for the application. The purchase activity may indicate one or more time references for at least one purchase made for the application. Based on the local application purchase activity, a request for promotion eligibility may be generated. The request for promotion eligibility may be transmitted to a media store. A response may be received that indicates that the user is eligible for a promotion. The response may be based upon information unavailable to the application. A promotion on the device may be received.

In an implementation, a system according to the presently disclosed subject matter includes a means for receiving from a requestor, a query for a promotion eligibility for one or more users. The system may include a means for obtaining user data that are unavailable to the requestor for the one or more users. The user data may be based on at least one of a user purchase history, a browsing history, and/or a content-specific history. The system may include a means for determining whether the one or more users is eligible for a promotion based on the query for the one or more users and the user data and a means for providing a response to the query to the requestor.

Additional features, advantages, and implementations of the disclosed subject matter may be set forth or apparent from consideration of the following detailed description, drawings, and claims. Moreover, it is to be understood that both the foregoing summary and the following detailed description provide examples of implementations and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows a computer according to an implementation of the disclosed subject matter.

FIG. 2 shows a network configuration according to an implementation of the disclosed subject matter.

FIG. 3 is an example process for determining promotion eligibility of one or more users in response to a query as disclosed herein.

FIG. 4 is an example of a process for generating a request for promotion eligibility by a local application and obtaining a promotion as disclosed herein.

FIG. 5 is an example system for determining promotion eligibility of one or more users in response to a query as disclosed herein.

### DETAILED DESCRIPTION

It may be beneficial to users and developers if developers of content in a media store have access to information that may be obtained based upon one or more users' interactions with the media store. A media store may offer, stream, or otherwise provide digital content (e.g., an application, a movie, a song, a book, etc.). A user may interact with the media store via an electronic device such as a smartphone, a computer, a tablet, etc. The media store may be launched as an application on a smartphone or accessed using a web browser, for example. A user may utilize an account that contains the user's credentials (e.g., a user name, a password, credit card information, electronic payment data, a purchase history, etc.) while accessing the media store to, for example, install an application or purchase a movie that can be played by the user's electronic device. The media store, therefore, may store information about user behavior and actions while utilizing the media store and/or applications related thereto. It may be desirable for developers to be able to provide promotions or other content to users who may be incentivized to make a purchase based on the analytic data collected or determined by the media store. Typically, such information is not made available to a developer to protect user privacy and/or preserve a user's anonymity. However, a media store may have access to a user's purchasing history including the value of purchases, the dates of those purchases, the subject of those purchases, a frequency of purchases, a timing of the purchases, instances where a user has viewed content for purchase but opted not to purchase it, linkage between such behaviors or histories, and similar information. Analyses may be performed on the data collected by the media store to group users and/or associate a particular user with criteria specified by a developer for selecting one or more users to receive a promotion.

For example, a user may perform a search for romance novels. The user may view the first result that appears for Frankenstein and, after spending an amount of time on the novel's web page on the media store site, decide against making a purchase. The user may then view the second result, Sense and Sensibility, and decide to purchase it. The media store may have information about the user's browsing habits on each page for Frankenstein and Sense and Sensibility. The information may indicate that the user read one or more selected excerpts, user reviews, and/or professional reviews and/or viewed or selected one or more external links. The information may also indicate a length of time that a user spent viewing or consuming content on each book's site page on the media store site. It may also indicate that the user opted not to purchase Frankenstein before opting to purchase Sense and Sensibility. Thus, analytic data may be obtained via the media store may include, for example, a purchase history, a browsing history, a device type, a user's location, a time reference, a click-through rate, a number of instances in which a user has been selected to receive a promotion and a corresponding success rate for a promotion (e.g., the number of instances in which the user utilized or otherwise activated the promotion), and a user profile.

As another example, some users may be frequent purchasers of content from the media store, such as applications, and/or content available within a particular application, such as “in-application” content. Examples of in-application content include features or enhancements purchased within an application such as a game, extensions or updates of existing applications other than those provided to all users of the application, cross-promoted items, such as where one application is available for purchase based upon an advertisement or other notification within another application, and the like. Other users may be less-frequent purchases of content, or may not have purchased content from the store previously. Developers may wish to provide promotions to users based upon the frequency or amount of purchases made within the store, including whether or not the user has previously made purchases from the store and/or from the developer's own content.

Developers who may offer their products and services to users may not be aware of what a user's purchase or browsing history is with respect to the media store. That is, a developer may not have information about whether a particular user is one who frequently makes purchases or not. Developers, therefore, may not be able to optimize their marketing investments or incentivize a segment of users that make purchases on the media store. Developers may offer incentives to all users irrespective of whether the users are new, highly engaged in purchase activity on the media store, or inactive on the media store. This may reduce the budget available for incentivizing users who may be more receptive to a directed promotion or incentive.

According to an implementation of the disclosed subject matter, an application programming interface (API) may be provided as a component of the media store or as a component of a particular device such as a mobile phone, a tablet, or a laptop. An application developer or other content provider may make a call to the API to determine whether a particular user who views and/or accesses the media store or an application doing the same is eligible for a promotion or incentive. The API may return a response of true or false based on a variety of criteria such as a user purchase history and/or browsing history. A user may be deemed eligible for a promotion or incentive for example, if it appears more likely than not that the user has made purchases in the past and may be inclined to make purchases in the future. For example, an application developer may wish to select specific users to receive promotion where the users have made purchases of $50 or more within the last ninety days and who are located in Russia. The API may determine a pool of users satisfying these criteria and who have downloaded the developer's application and return a true/false indication as to whether each user in the pool is available for a promotion. A true response may indicate that the user falls into those criteria.

A promotion or incentive may refer to, for example, a discount, a promotional code, a gift card, a give-away, a redeemable coupon (electronic or otherwise), an upgrade to an application or content, or the like. An upgrade to an application may be, for example, providing additional chapters of a book for free or at a discount, allowing a character in a game to receive upgrades at no cost that would normally cost the user some form of in-game currency, or the like. A promotion need not be tied to a particular application or content from which the promotion eligibility request is made. For example, a user may be playing Game A. The developer for Game A may be interested in determining whether or not the user is promotion eligible. The user, being determined to be promotion eligible, may receive a promotion for another application at a discount by the same developer.

In some instances, the API may return a false answer in response to the query where either the user is not eligible for a promotion or the user has been randomly selected to be ineligible. At a specified frequency, the API may return a response to the query that a user is not eligible for a promotion and/or incentive even if the user otherwise would be eligible according to the criteria provided above (e.g., a purchase history and/or a browsing history). The randomization of the API's response may be performed to protect a user's privacy. For example, a developer may wish to select users for a promotion if they reside in Canada, have made a content purchase within the last week, and have purchased at least one application upgrade feature within the last year. Ten users, Users 1-10, may fall into the criteria specified by the developer. All ten Users would ordinarily return a “true” for a promotion eligibility request. A randomization function may be applied to the results of the promotion eligibility request such that irrespective of the promotion/incentive eligibility determination, a response of false/ineligible will be returned for a subset of the Users queried. In this example, the developer may receive an indication that User 1 is ineligible for a promotion/incentive. This may protect User 1's privacy because the developer cannot be sure that User 1 actually falls outside of the criteria specified or if User 1 has been subject to the randomization function that has overridden the promotion eligibility API Similarly, the same or a different percentage of the time, for a user for which a “false” response would be given, the API may return a “true” response instead. Thus, the fact that the API provides a “true” or “false” response in any particular instance may not indicate to a requestor that a user does in fact meet the criteria used to determine whether the user is eligible for a promotion. The randomization function or functions may be configured to be virtually any number to vary the size of the subset of users who match or do not match the criteria but who are excluded or included, respectively, to prevent information about a specific user from becoming known to a developer or the like.

Another technique to ensure that privacy is protected may be to select criteria for signals that are mixed between positive or negative, so that a single true/false response does not necessarily indicate the presence of an element that is to be kept private. This may be useful, for example, to ensure that removing a certain percentage of users from getting a defined true/false signal does not indicate the presence of a secret element. For example, if the presence of an active purchasing account is used as one of the criteria to return a true/false response, it may be useful for the API to randomly return an “incorrect” true/false response so that the response itself does not indicate whether the user has an active purchasing account in any particular instance.

Privacy also may be bolstered by the API providing a response only for a binary query (e.g., yes/no, true/false, or eligible/ineligible). Further, in configurations where the API operates in conjunction with the media store, it reduces the developer's need to ask for a user's personal information in advance because the API obscures the user's identity from the developer.

Further, the abstraction of the user data and related analytics to a simple query, such as the binary query described above, may be beneficial to developers using the API. For example, instead of each developer being required to collect and analyze user data for a multitude of users, and to rely on only that data which is collected by their own applications, each developer may simply access the API as previously described and obtain an indication of whether a particular user is eligible or a promotion. This may be significantly less complex, and thus require significantly less development and testing time, than an alternative arrangement in which each developer makes an eligible/ineligible determination independently.

In some configurations, a third party application may query the API to determine if a user has ever made a purchase before or has never made a purchase before. The third party application (or developer thereof) may be interested in knowing whether or not the user has an active form of payment (e.g., gift card, promotional code, etc.) or is a lapsed buyer. A lapsed buyer may refer to a user who has not made a purchase via the media store or a particular application associated therewith within a specified interval of time. The third party application developer may, for example, use the response to the eligibility query to offer promotions and/or in-game achievements for unlocking payments or the like. It also may be desirable to prevent developers from determining, for example, if a particular user has an active payment account with the media store. For example, the media store may implement a privacy policy which prevents other entities from obtaining specific information about a user's payment account or lack thereof; similarly, some jurisdictions may require that this and similar information is not provided to third parties by entities such as a media store. In such a situation, the use of a randomization factor as previously described may provide an appropriate level of privacy protection. For example, if the API randomly returns a true/false result 20% of the time, when a developer queries the API and determines that a user is eligible or ineligible for a promotion, the developer may not know with any reasonable certainty whether that user in fact has an active payment account. As another example, criteria may be selected partially to prevent such information from being revealed by the true/false responses returned by the API As a specific example, a true response may be configured to mean either that no account is associated with the user, or that an account has not been used in some length of time, and a false response may be returned for users either who have an active account, or, for a random percentage of users without accounts, who were disqualified from returning a true result. Thus, neither a true or false response from the API indicates the presence of an active account. Further, even in situations where a developer is able to specify certain criteria, such as “has an active payment account,” which should contribute to the determination of whether a user is eligible for a promotion, the developer may not be able to discern that a user does in fact have an active payment account based merely on the result of the API call.

Promotions described herein may be provided by the developer or third party making the request via the API, or they may be provided by the media store itself. For example, an application may request, via the API, a determination of whether a particular user is eligible for a promotion or not. Upon so determining, the media store may proceed to provide a predetermined or dynamically-generated promotion to the specific user. Such a configuration may provide a higher degree of convenience to developers, who need not then also provide a mechanism to deliver a promotion to the selected user. Further, it may provide a further privacy benefit to users, since the developer will not know whether the user is eligible for the promotion or not.

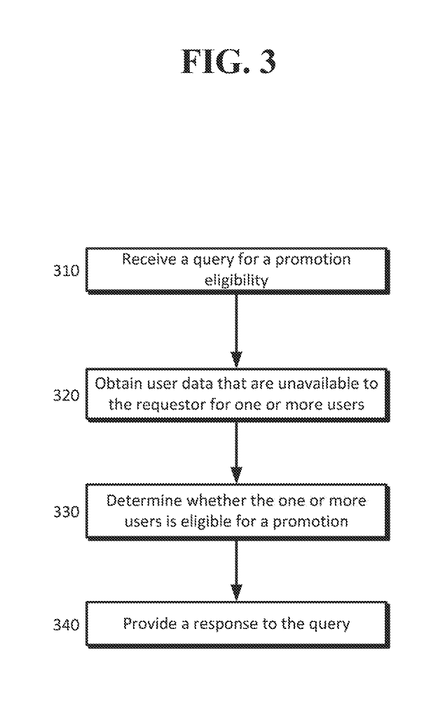

In an implementation, an example of which is provided in FIG. 3, a query for a promotion eligibility for one or more users may be received from a requestor at 310. A requestor may be a developer or a third party acting on behalf thereof as described earlier, for example. The query may specify one or more criteria which can be utilized to filter the available pool of users for whom the requestor is attempting to ascertain promotion eligibility. User data that are unavailable to the requestor may be obtained at 320. The user data may be based on at least one of a user's purchase history, a browsing history, and a content-specific history and/or a representation of the aforementioned. Other forms of user data may be obtained and utilized as a basis for determining promotion eligibility such as a user's age group, geographic location, etc. A content-specific history may refer to a genre or type of content, such as Victorian romance novels. A representation of a purchase history, for example, may be the result of an analysis that incorporates the purchase history data.

A determination may be made as to whether one or more users is eligible for a promotion based on the query for the one or more users and the user data at 330. For example, in honor of Canada Day, a query may specify that a developer would like to offer an in-application promotion for Game XYZ to users in Canada who are estimated to have a 65% likelihood of making an in-application purchase. The system may filter the available pool of users based on those who live in Canada (e.g., based on user provided or GPS-determined location), have installed the developer's application for which the promotion is being offered. An estimation of purchase likelihood may be calculated based on a user's past purchase history and game activity history. For example, if a user has ever made a purchase of any type either via the media store or within an application, the user may be assigned a value of five points. If the user has made an in-application purchase for any of the developer's applications, the user may be assigned three points. If the user has made an in-application purchase for Game XYZ, the user may be assigned four points. If the user has played Game XYZ within the last three days, the user may be assigned three points. Similarly, if the user has played Game XYZ between three and thirty days, the user may be assigned two points. And if the user has played Game XYZ, but only during the period between one to three months ago, the user may receive one point. A maximum point total for a user, based on this example, would be fifteen points. The likelihood of purchase, in this example, may be determined as a percentage of fifteen points that are assigned to each of the users from among the filtered pool (e.g., those users who have a geographic location of Canada and who have Game XYZ installed). Other methods of determining a likelihood of purchase, other data, and other metrics may be may be employed in accordance with the implementations disclosed herein.

A response to the query may be provided or returned to the requestor at 340. Continuing the previous example, the requestor (e.g., developer in this example) may receive an indication of how many users are promotion eligible based on the criteria the requestor provided in the query and the user data that is not available to the developer. In some configurations, a requestor may specify that promotion eligible users are to be sent a promotion. In some configurations, a requestor may be asked to input or otherwise provide the details of the promotion in order to proceed with dispatching the promotion to those users determined to be promotion eligible. Alternatively, the requestor may provide the promotion prior to or coincident with submission of the request. The promotion itself may be provided to selected users (e.g., those returned in response to the query for promotion eligible users) using a variety of techniques such as email, in-application, in-content, a hyperlink, and/or a text message.

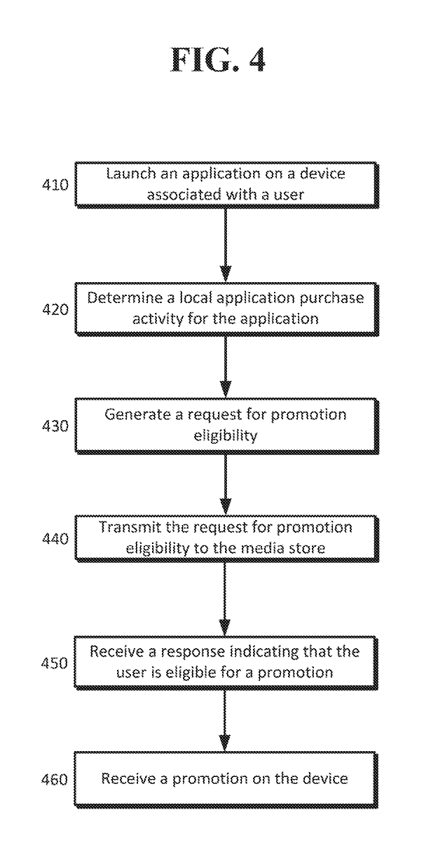

In an implementation, an example of which is provided in FIG. 4, an application may be launched on a device associated with a user at 410. For example, the user may log into the device with the user's credentials or otherwise have an account associated with the user linked to the device. The application may record a history of purchases made by the user which may include a time reference for each purchase made, if any at 420. The application may be automatically launched as a part of the operating system (e.g., a service) and/or at the request of the user. The local application may store an indication of a purchase history and/or other behavior of the user with the device and it may upload the indication periodically for processing by a remote server. In some instances, the application may be the one for which a promotion eligibility is queried. For example, Game XYZ may store user data about its usage (e.g., activity times, length of use, in game activities, purchase activity, etc.) and be responsible for generating a request for promotion eligibility. Game XYZ may be from the same developer as Application ABC and both applications may store user data and have access to each other's stored user data.

A request for promotion eligibility may be generated at 430, for example, at specified time points or dynamically based on a trigger event (e.g., the user makes an application purchase from a media store, utilizes an application for a specified length of time, completes a particular task with the application, etc.). For example, the local application purchase history may indicate that the user has made several purchases in the past, but none within the last three months. The local application may be configured to contain initial criteria to determine whether or not a promotion eligibility request should be made to the media store. For example, a promotion eligibility request may be generated at 430 if the user has demonstrated a willingness to make purchases within the past year, but has lapsed in making a purchase for at least two months. The application may make use of the promotion eligibility API described earlier and generate a request to ascertain whether the user is promotion eligible or not at 440. A developer may provide one or more criteria and a weight therefor to the media store and/or the application. As stated earlier, the application may compute one or more metrics (e.g., purchase likelihood) prior to transmitting the request for promotion eligibility and the metrics may be based on the one or more criteria provided by the developer. If, for example, a metric computed by the application indicates that a purchase likelihood is above a predetermined threshold value (e.g., a value set by the application developer as “criteria”), then the application may generate the request for promotion eligibility at 430 as described above.

The request for promotion eligibility may be transmitted to the media store at 450. A response from the API may indicate that the user is eligible for a promotion at 460. For example, the API may base its response on a determination that this particular user has made other purchases for other applications within the last three months and that those purchases were of a type similar to the ones offered in the subject application. A promotion may be received on the device at 470 and presented to the user by the application, email, text message, etc. For example, the application may offer a 30% discount on an in-game currency purchase to the user when the user launches the game again.

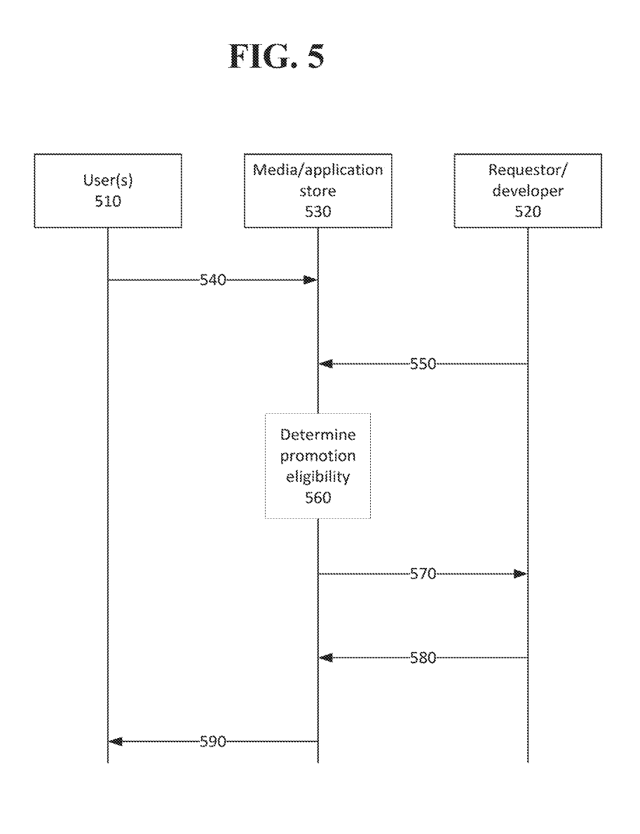

An example of a system disclosed herein is shown in FIG. 5. The system includes a database for storing purchase information or other user data for one or more users 510, for example, associated with a media store 530. At 540, a user may maintain an account with a media/application store 530. The user's account may be associated with other services utilized by the user (e.g., email, social network, etc.). Thus, the user data may be obtained from a variety of sources and available to the media/application store at 540. A processor may be communicatively coupled to the database and configured to receive a query for a promotion eligibility for one or more users as described above at 550. The processor may be associated with the media store 530. User data for the one or more users may be obtained as described earlier. In some configurations, one or more purchase metrics for a user may be predetermined by the system and/or dynamically updated as more user data about the one or more users is obtained. For example, if a user recently begins making in-application purchases for tower defense games, a user purchase likelihood score, as described above, may increase. Similarly, if a user uninstalls a series of role playing games (“RPGs”), a user's interest in RPGs may be represented as decreased. In some instances, a metric may be calculated irrespective of whether or not a query has been received. For example, the system may anticipate that a developer or requestor 520 would likely want to make a promotion eligible to only users who have a certain purchase likelihood. In some instances, the metric, whether or not it is predetermined, may be computed or recomputed to account for criteria supplied by the requestor/developer 520. The processor may determine whether the one or more users is eligible for a promotion based on the query for the one or more users and the user data at 560. In FIG. 5, step 560 is shown as being performed by the media/application store 530; however, the process may be performed by a processor connected to the database that is remote from the media/application store 530. A response to the query may be provided at 570 to the requestor 520. As disclosed above, the response may be a binary response such as a true/false or yes/no and that response may be tempered with a randomization function. The requestor/developer 520 may provide instructions based on the query response to dispatch a promotion to the users deemed eligible at 580. The promotion may be dispatched to the one or more users 510 at 590.

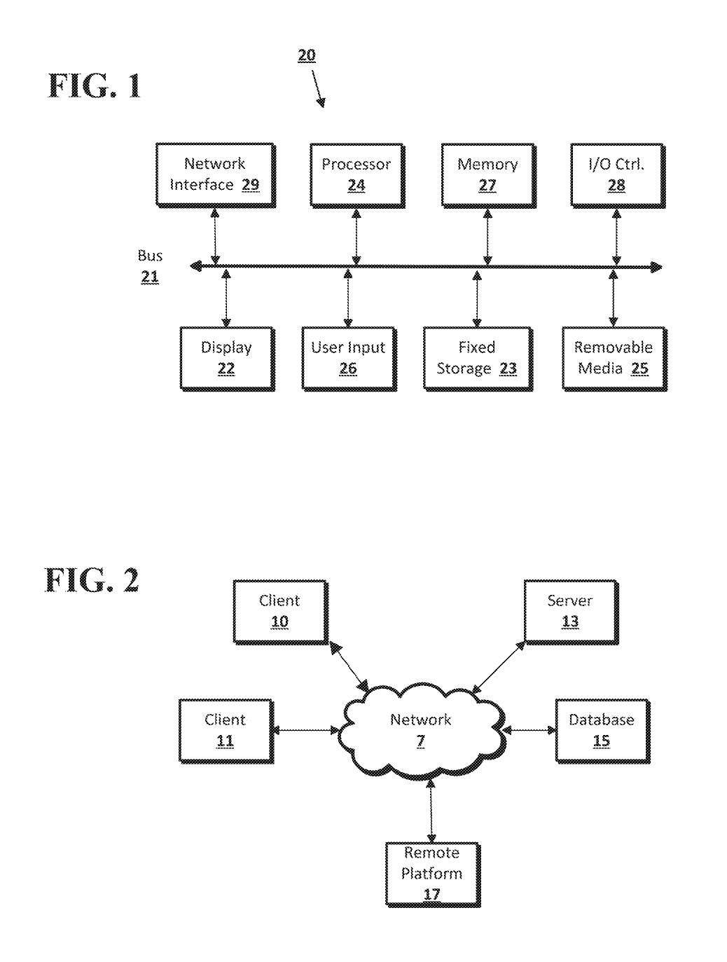

Implementations of the presently disclosed subject matter may be implemented in and used with a variety of component and network architectures. FIG. 1 is an example computer 20 suitable for implementations of the presently disclosed subject matter. The computer 20 includes a bus 21 which interconnects major components of the computer 20, such as a central processor 24, a memory 27 (typically RAM, but which may also include ROM, flash RAM, or the like), an input/output controller 28, a user display 22, such as a display screen via a display adapter, a user input interface 26, which may include one or more controllers and associated user input devices such as a keyboard, mouse, and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may allow the computer to communicate with other computers via one or more local, wide-area, or other networks, as shown in FIG. 2.

Many other devices or components (not shown) may be connected in a similar manner (e.g., document scanners, digital cameras and so on). Conversely, all of the components shown in FIG. 1 need not be present to practice the present disclosure. The components can be interconnected in different ways from that shown. The operation of a computer such as that shown in FIG. 1 is readily known in the art and is not discussed in detail in this application. Code to implement the present disclosure can be stored in computer-readable storage media such as one or more of the memory 27, fixed storage 23, removable media 25, or on a remote storage location.

FIG. 2 shows an example network arrangement according to an implementation of the disclosed subject matter. One or more clients 10, 11, such as local computers, smart phones, tablet computing devices, and the like may connect to other devices via one or more networks 7. The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

In situations in which the implementations of the disclosed subject matter collect personal information about users, or may make use of personal information, the users may be provided with an opportunity to control whether programs or features collect user information (e.g., a user's provided input, a user's geographic location, and any other similar data associated with a user). In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1-17. (canceled)

18. A method for analyzing data related to interactions between a first computing device and a plurality of second computing devices, comprising:
producing, by the first computing device, the data related to the interactions between the first computing device and the plurality of second computing devices;
receiving, by the first computing device, a request, from a third computing device, for an analysis to be performed on the data, the data related to the interactions between the first computing device and the plurality of second computing devices being isolated from the third computing device, the analysis based on at least one criterion and directed to determining an eligibility of a user of one of the plurality of second computing devices to receive a promotion or an incentive;
performing, by the first computing device, the analysis; and
transmitting, by the first computing device, a result of the analysis to the third computing device.

19. The method of claim 18, wherein the data include at least one of a history of at least one purchase associated with the user of the one of the plurality of second computing devices, a value of the at least one purchase, a date of the at least one purchase, a subject of the at least one purchase, a frequency of the at least one purchase, a timing of the at least one purchase, an instance in which the user has viewed a content for purchase but has not purchased the content, a duration of time consumed by the user in viewing the content, an instance in which the user has viewed information related to the content, information indicative of a pattern of viewing the content before making the at least one purchase, a provider of the subject of the at least one purchase, or information that indicates that the at least one purchase was offered for sale within an application.

20. The method of claim 18, wherein the data are further related to other information, the other information being about the user of the one of the plurality of second computing devices.

21. The method of claim 20, wherein the other information includes at least one of a browsing history, a device type of the one of the plurality of second computing devices, a location of the user, a time reference, a click-through rate, a number of instances in which the user has been selected to receive the promotion, a number of instances in which the user utilized the promotion, a number of instances in which the user activated the promotion, or a user profile.

22. The method of claim 18, wherein the at least one criterion includes at least one of a purchase history of the user, a browsing history of the user, a value of a purchase by the user, a timing of the purchase, or a location of the user.

23. The method of claim 18, wherein the result has a binary form.

24. The method of claim 18, further comprising:
determining, by the first computing device, that the user of the one of the plurality of second computing devices has been randomly selected to be ineligible to receive the promotion or the incentive,
wherein the performing the analysis comprises producing an indication that the user of the one of the plurality of second computing devices has been randomly selected to be ineligible to receive the promotion or the incentive.

25. A non-transitory computer-readable medium storing computer code for controlling a processor, the computer code including instructions to cause the processor to:
produce data related to interactions between a first computing device and a plurality of second computing devices;
receive a request, from a third computing device, for an analysis to be performed on the data, the data related to the interactions between the first computing device and the plurality of second computing devices being isolated from the third computing device, the analysis based on at least one criterion and directed to determining an eligibility of a user of one of the plurality of second computing devices to receive a promotion or an incentive;
perform the analysis; and
transmit a result of the analysis to the third computing device.

26. The non-transitory computer-readable medium of claim 25, wherein the data include at least one of a history of at least one purchase associated with the user of the one of the plurality of second computing devices, a value of the at least one purchase, a date of the at least one purchase, a subject of the at least one purchase, a frequency of the at least one purchase, a timing of the at least one purchase, an instance in which the user has viewed a content for purchase but has not purchased the content, a duration of time consumed by the user in viewing the content, an instance in which the user has viewed information related to the content, information indicative of a pattern of viewing the content before making the at least one purchase, a provider of the subject of the at least one purchase, or information that indicates that the at least one purchase was offered for sale within an application.

27. The non-transitory computer-readable medium of claim 25, wherein the data are further related to other information, the other information being about the user of the one of the plurality of second computing devices.

28. The non-transitory computer-readable medium of claim 27, wherein the other information includes at least one of a browsing history, a device type of the one of the plurality of second computing devices, a location of the user, a time reference, a click-through rate, a number of instances in which the user has been selected to receive the promotion, a number of instances in which the user utilized the promotion, a number of instances in which the user activated the promotion, or a user profile.

29. The non-transitory computer-readable medium of claim 25, wherein the at least one criterion includes at least one of a purchase history of the user, a browsing history of the user, a value of a purchase by the user, a timing of the purchase, or a location of the user.

30. The non-transitory computer-readable medium of claim 25, wherein the result has a binary form.

31. The non-transitory computer-readable medium of claim 25, further including instructions to cause the processor to:
determine that the user of the one of the plurality of second computing devices has been randomly selected to be ineligible to receive the promotion or the incentive,
wherein the instructions to cause the processor to perform the analysis comprise instructions to cause the processor to produce an indication that the user of the one of the plurality of second computing devices has been randomly selected to be ineligible to receive the promotion or the incentive.

32. A first computing device for analyzing data related to interactions between the first computing device and a plurality of second computing devices, comprising:
a processor configured to:
produce the data related to the interactions between the first computing device and the plurality of second computing devices;
receive a request, from a third computing device, for an analysis to be performed on the data, the data related to the interactions between the first computing device and the plurality of second computing devices being isolated from the third computing device, the analysis based on at least one criterion and directed to determining an eligibility of a user of one of the plurality of second computing devices to receive a promotion or an incentive;
perform the analysis; and
transmit a result of the analysis to the third computing device; and
a memory configured to store the data related to the interactions between the first computing device and the plurality of second computing devices.

33. The first computing device of claim 32, wherein the data include at least one of a history of at least one purchase associated with the user of the one of the plurality of second computing devices, a value of the at least one purchase, a date of the at least one purchase, a subject of the at least one purchase, a frequency of the at least one purchase, a timing of the at least one purchase, an instance in which the user has viewed a content for purchase but has not purchased the content, a duration of time consumed by the user in viewing the content, an instance in which the user has viewed information related to the content, information indicative of a pattern of viewing the content before making the at least one purchase, a provider of the subject of the at least one purchase, or information that indicates that the at least one purchase was offered for sale within an application.

34. The first computing device of claim 32, wherein the data are further related to other information, the other information being about the user of the one of the plurality of second computing devices.

35. The first computing device of claim 34, wherein the other information includes at least one of a browsing history, a device type of the one of the plurality of second computing devices, a location of the user, a time reference, a click-through rate, a number of instances in which the user has been selected to receive the promotion, a number of instances in which the user utilized the promotion, a number of instances in which the user activated the promotion, or a user profile.

36. The first computing device of claim 32, wherein the at least one criterion includes at least one of a purchase history of the user, a browsing history of the user, a value of a purchase by the user, a timing of the purchase, or a location of the user.

37. The first computing device of claim 32, wherein the result has a binary form.

38. The first computing device of claim 32, wherein the processor is further configured to determine that the user of the one of the plurality of second computing devices has been randomly selected to be ineligible to receive the promotion or the incentive, and wherein the processor is configured to perform the analysis by producing an indication that the user of the one of the plurality of second computing devices has been randomly selected to be ineligible to receive the promotion or the incentive.
